(19) United States
(12) Patent Application Publication
(10) Pub. No.: US 2014/0305201 A1
(43) Pub. Date: Oct. 16, 2014

(54) Electronic liquid level sensing device and gauge for liquid-immersed power transformers, reactors and similar equipment

(71) Applicant: Joe David Watson, Jupiter, FL (US)

(72) Inventor: Joe David Watson, Jupiter, FL (US)

(21) Appl. No.: 13/861,689

(22) Filed: Apr. 12, 2013

(51) Int. Cl. G01F 23/18

(52) U.S. Cl. CPC G01F 23/18
USPC 73/290 R

(57) ABSTRACT

An electronic liquid level measuring device and gauge for liquid-immersed transformers, reactors or similar equipment with complex and dynamic liquid temperature distributions that utilizes measured liquid pressure and temperature measurements with programmed settings and algorithms to determine the level and volume of liquid in the equipment. The measuring device also has capabilities of providing output data or display for the liquid level, liquid volume, and measured data, as well as alarms for adverse operating conditions.

### BACKGROUND

Liquid-immersed power transformers, reactors and similar equipment are filled with a liquid to provide electrical insulation for, and transfer heat from, an energized internal component such as the core and windings, also referred to as the active part in the case of a transformer. The liquid can be mineral oil, synthetic oil, vegetable oil, or other liquids that provide the thermal and electrical performance requirements. In these specifications, the terms liquid or oil and the terms transformer or reactor have the same meaning.

The oil volume must be maintained at a level that is sufficient to cover all energized parts that need electrical insulation to prevent electrical failure, as well as a sufficient volume to transfer the heat energy produced by the active part to the radiators or heat exchangers for heat removal and maintaining the active part at safe operating temperatures where thermal damage will not occur.

Liquid-immersed transformers have oil containment systems that can be classified in two general categories for the purpose of this invention, gas-blanketed or equipped with oil expansion tanks. Both systems allow the oil level to rise and fall within a normal operating range with dynamic changes in operating and ambient temperatures.

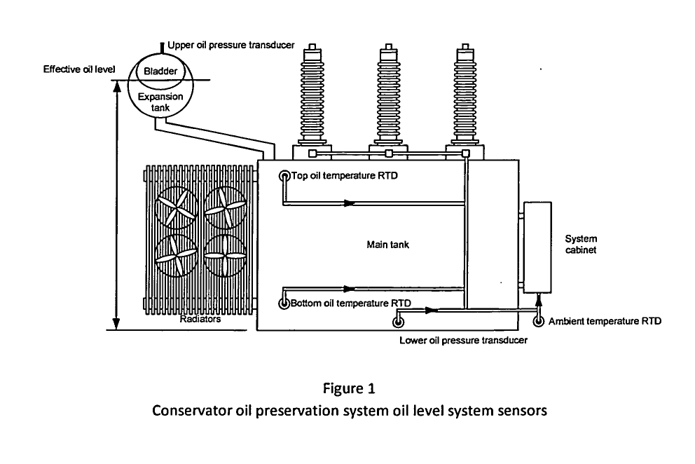

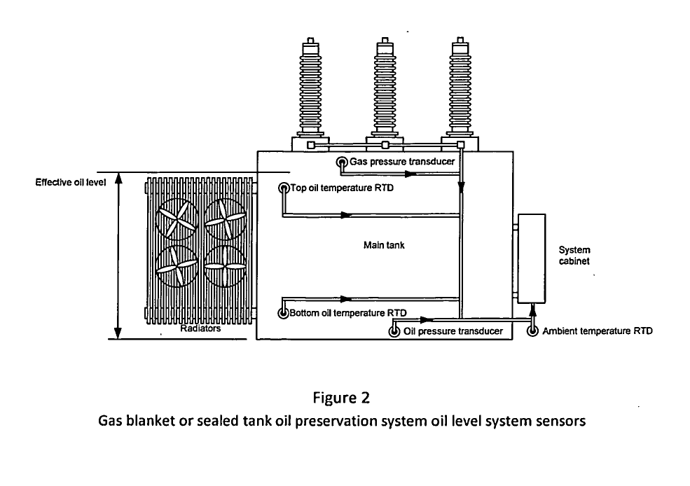

The current state of the art for oil level gauges is a mechanical gauge with a float mounted to a float arm. The top oil level in transformers with expansion tanks rises and falls within its' normal operating range in an expansion tank as shown in FIG. 1. The top oil level in transformers with gas-blanketed designs rises and falls within its' normal operating range in the main transformer tank as shown in FIG. 2. In transformers with expansion tank designs, typical mechanical oil level gauges are mounted on the expansion tank with a long float arm inside the expansion tank that floats at the top level of the oil. In transformers with gas-blanketed designs, a typical mechanical gauge is mounted on the tank wall and utilizes an internal radial float arm that floats at the top level of the oil.

Mechanical gauges have a few drawbacks:
Limited range of operation: The float arm can only move over a limited range so liquid levels below the minimum level or above the maximum level cannot be measured with a single gauge.
Float arms can be bent or damaged easily
Float arms and floats can cause damage to flexible bladders that are often used inside expansion tanks to isolate the liquid from the outside air
Damaged flexible bladders can collapse inside the expansion tank and lay on top of the float arm, preventing the float arm from floating at the top level of the liquid and displaying a correct oil level
Mechanical gauges are constructed in two magnetically coupled parts and require gasketed seals between the internal float arm assembly and the outside gauge display assembly. These gasket seals degrade with time and temperature, and can be damaged by improper installation or maintenance, causing oil leaks and environmental problems.
Mechanical gauges may be located in an area that is difficult to see due to interferences at the service location. Relocating mechanical gauges is not practical.
The vast majority of mechanical oil level gauges are equipped with micro-switches to provide high and low level alarms, but the measured liquid level can only be determined by looking at the gauge, although some gauges have been developed recently with remote level indication.
A mechanical gauge can only indicate liquid level, and cannot determine liquid volume because it does not measure or compensate for liquid temperature which can lead to improper filling when the transformer is filled with oil or similar problems.

### SUMMARY OF THE INVENTION

The invention is a unique system for liquid-immersed transformers and reactors with complex internal thermal gradients that provides the level and volume of the liquid without the need for mechanical gauges. The system measures the pressure above the oil and near the bottom of the tank and measures the top and bottom oil temperatures. Using the measured temperatures, the invention calculates the estimated average oil temperature and corresponding estimated average specific gravity of the oil from the various regions of oil in the tank. This data is then used to calculate an estimated oil level, or oil height above the pressure transducer, using Pascal's law. The estimated oil height is then used to calculate the estimated oil volume, using calculations specific to the shape and dimensions of the expansion tank. The estimated oil expansion is then used to also calculate the corresponding average oil temperature. If the estimated average oil temperature used to calculate the estimated oil height does not agree with the average oil temperature calculated from the resulting oil volume at the estimated oil height, within the required accuracy level, the average value of the two different temperatures is calculated then the oil height and oil volume are recalculated and this iteration process is repeated until the results are within the required accuracy level. The process must be repeated regularly on a time based cycle, or when measured data change more than pre-set bandwidth values.

The invention offers the following improvements over the prior art.
The elimination of a float assembly and the corresponding ability to determine the oil level at any volume in the tank from 0 to 100%, also eliminating the need for multiple oil level gauges on some transformers
The ability to discern the difference between a low oil level that is due to incomplete filling or lower than expected temperatures and a low oil level that is due to loss of oil in the tank from leaks or oil removal
The ability to locate the display at any location on the transformer, or at a remote location, or at multiple locations
The ability to relocate the display if the transformer was designed with the display at a location that is not what is needed by the transformer owner
The ability to detect over-pressure conditions before oil is released
The ability to detect high or low gas pressure conditions in gas blanketed or sealed tank transformers
The ability to detect clogged breathers in conservator type transformers
The ability to provide reliable oil level data even if the bladder is damaged in a conservator type transformer
The ability to issue alarms based on trending data, before the alarm condition occurs

### The Invention

In the drawings, which form a part of this specification,

FIG. 1 is a typical conservator oil preservation type transformer with the pressure and temperature sensor general locations shown, as well as effective liquid level that is measured by the invention.

FIG. 2 is a typical gas blanket or sealed tank oil preservation type transformer with the pressure and temperature sensor general locations shown, as well as effective liquid level that is measured by the invention.

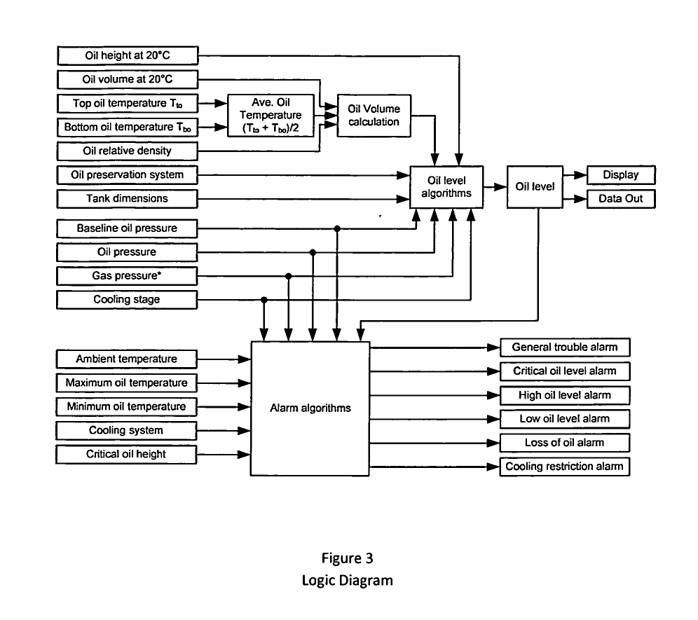

FIG. 3 shows the invention's general input and output signal flow or logic diagram.

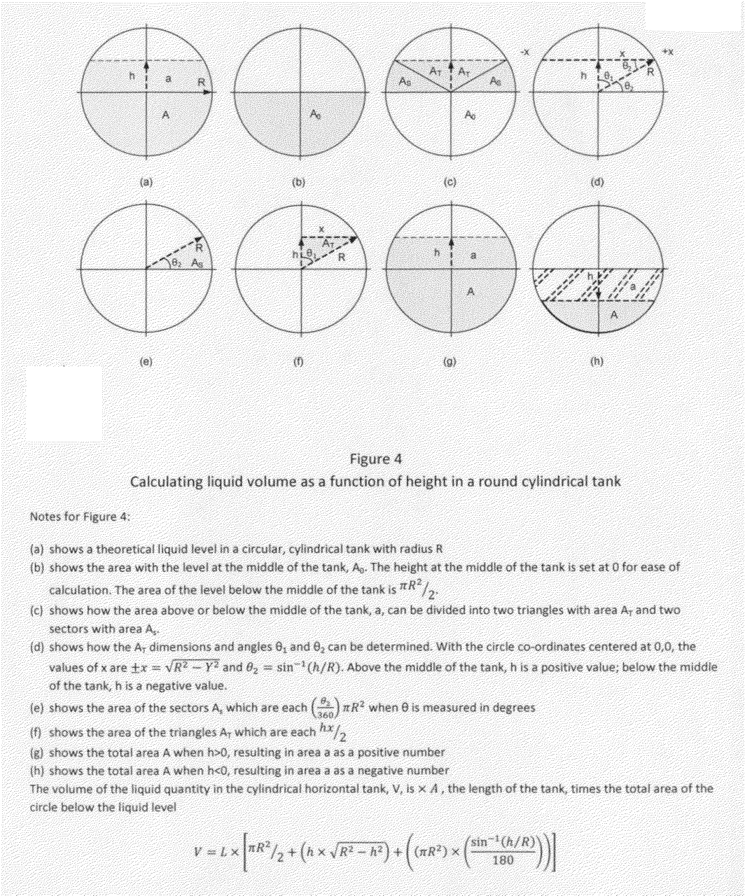

FIG. 4 and the notes for FIG. 4 explain a method to calculate the liquid volume at various levels in a round, cylindrical expansion tank as a function of the calculated, liquid level.

The pressure of the oil at the bottom of the transformer tank, above the pressure at the top level of the oil is related to the height of the oil above the pressure sensor by Pascal's law, P=ρgh.

Where P=the pressure, ρ=the oil specific gravity, g=the gravitational constant and h=the height and ρ is a function of the oil expansion constant, β, and temperature or ρ₁=ρ₀β(t₁−t₀)

The reference oil temperature t₀ is the average liquid temperature which is measured when the tank is filled with the liquid at a consistent temperature. The calculated average oil temperature t₁ is initially the average of the measured top and bottom liquid temperatures.

The average oil temperature, calculated as the average of the oil temperature measured near the top of the tank and the oil temperature measured near the bottom of the tank, is used to estimate the specific gravity and thermal oil expansion of the oil in the tank which is distributed in a complex arrangement of thermal gradients throughout the tank due to the dynamic operating conditions and heating inside the tank.

The measured pressure value will vary with thermal expansion or contraction and corresponding rise or fall of the oil level in conservator expansion tanks and the corresponding thermal change in the specific gravity of the oil. The relationship between the change in oil volume and change in oil level in the expansion tank will depend on the geometry and dimensions of the expansion tank.

The volume of oil in a transformer with an expansion tank is modeled as the volume of oil below the expansion tank, which must be measured and thermally corrected when the transformer is filled, plus the volume of oil in the expansion tank which can be calculated from the internal tank geometry and dimensions. Calculation methods for the liquid volume in a round cylindrical expansion tank are shown in FIG. 4. The volume of oil in a gas-blanketed transformer, without an expansion tank, is modeled as the volume of oil below the normal oil level at 20° C., which must be measured and thermally corrected when the transformer is filled, plus the volume of oil above the normal oil level which can be calculated from the internal geometry of the tank. The oil volume of the part of the transformer tank containing the active part would be difficult to accurately calculate due to the geometries and oil absorption of insulation materials, so a measurement of the oil volume required to fill the transformer to the desired level is required.

The invention's oil level measurement and calculation process is as follows:

The pressure, P, is measured at the bottom of the tank and the upper and lower oil temperatures are measured to calculate the average oil temperature, t₁, and the specific gravity of the oil at the average oil temperature, ρ₁.

The oil height is calculated as h=P/_{ρ}_{₁}_{g}

The calculated oil height is then used to calculate the total volume of oil in the transformer and expansion tank, for expansion tank designs, or in the transformer tank for gas-blanketed transformer designs.

The total calculated oil volume is then used to calculate the average oil temperature, t₁, using the oil expansion constant and volume at 20° C. and the following calculation:

V₁=V₀/β(t₁−t₀)

where:
V₁ is the calculated oil volume at the measured temperature t₁
V₀ is the measured oil volume at the reference oil temperature t₀ (20° C. is a commonly used reference temperature but the volume could be measured at another temperature and corrected to 20° C.)
β is about 0.0007/° C. for transformer oil which can be used as a default value, or tested data from the oil can be used for more accuracy)
t₁ is the average oil temperature, originally estimated as (t_{TOP}+t_{BOTTOM})/2

The calculated average oil temperature, t₁, from the oil volume calculation is then compared to the average oil temperature, t₁ used in the height calculation with the measured pressure. If the two t₁ values are outside the required tolerance, the two values are averaged and the calculation process is reiterated until the required accuracy level is met.

This re-iteration process compensates for the complex and dynamic thermal distributions of circulating oil within the transformer that can only be approximated with the measured top and bottom oil temperatures.

The dynamic liquid level height is displayed on a remote screen or gauge, and the operational algorithms periodically calculate the maximum and minimum liquid levels at the ambient temperature and operational limits.

Any reduction in the calculated oil volume is an indication that oil is leaking, or has been removed, from the transformer.

The invention requires settings programmed into non-volatile memory to enter the oil relative density, normal oil volumes and oil level and oil volume at the bottom of an expansion tank (if equipped) at 20° C., baseline oil pressure at the bottom of the tank, critical oil level, maximum and minimum designed oil temperatures, cooling system (if equipped with pumps, the pump operation sequence is also entered), oil preservation system and tank dimensions (tank dimensions for sealed or gas-blanket preservation systems, and expansion tank dimensions for conservator type preservation systems). The system utilizes sensors to provide oil temperatures at the top and bottom of the tank, gas pressure at 20° C. (for sealed-tank systems), oil pressure at the top and near the bottom of the oil level, and cooling stage (for cooling systems equipped with pumps).

The critical oil level alarm is activated when the calculated oil level is below the critical oil level setting as a result of excessive thermal contraction or a loss of oil. This alarm can also be set to be activated when the oil pressure indicates a loss of oil that is above the critical oil level at the current average oil temperature, but would be below the alarm level at the minimum specified ambient or oil temperature.

The high oil level alarm is activated when the temperature corrected oil level, gas pressure and oil pressure calculations indicate an oil level above the designed maximum oil level setting. This alarm can also be set to be activated when the oil pressure indicates an excess quantity of oil, as a result of improper filling, for example, a level that is below the designed maximum oil level at the current average oil temperature, but would be above the alarm level at the maximum specified oil temperature.

The low oil level alarm is activated when the temperature corrected oil level, gas pressure, and oil pressure calculate an oil level below the designed minimum oil level setting. This alarm can also be set to be activated when the oil pressure indicates a loss of oil that is above the designed minimum oil level at the current average oil temperature, but would be below the alarm level at the minimum specified ambient temperature.

The loss of oil alarm is activated when the oil pressure and gas pressure calculate a loss of oil that is outside the bandwidth of the normal range and would indicate a loss of oil. The accuracy of the pressure transducers should be selected to provide a sufficiently small bandwidth of calculated oil mass during normal operation. Since it is common practice to remove one to two liters of oil once or more each year for laboratory testing, this alarm would be activated and the invention should include a reset function of the oil volume and quantity after such samples are taken to recalibrate the calculated oil level.

The cooling restriction alarm is activated if the cooling system uses oil pumps and the oil pressure increases above the normal values under the cooling stages when the pumps are operating, indicating a physical restriction in the oil flow through the active part of the transformer, or in the cooling circuit as a result of a closed valve that should be open, or some other restriction in the oil circuit.

The device also has a general trouble alarm that is activated in the event of loss of power, low gas pressure, a sensor failure, or a system failure that results in calculated values outside the expected range under the monitored conditions, for example a calculated oil level above the maximum designed level with normal gas and oil pressure values.

### Preamble

The invention is an electronic liquid level sensing device and liquid level gauge that utilizes measured and programmed data to determine the liquid level in a liquid-immersed transformer or reactor or similar devices with complex fluid temperature distributions and/or complex tank geometries. The invention offers the following functions wherein the improvement comprises:
The elimination of a float assembly and the corresponding ability to determine the oil level at any volume in the tank from 0 to 100%, also eliminating the need for multiple oil level gauges on some transformers
the ability to discern the difference between a low oil level that is due to incomplete filling or lower than expected temperatures and a low oil level that is due to loss of oil in the tank from leaks or oil removal
the ability to locate the display at any location on the transformer, or at a remote location, or at multiple locations
the ability to relocate the display if the transformer was designed with the display at a location that is not what is needed by the transformer owner
the ability to detect over-pressure conditions before oil is released
the ability to detect high or low gas pressure conditions in gas blanketed or sealed tank transformers
the ability to detect clogged breathers in conservator type transformers
the ability to provide reliable oil level data even if the bladder is damaged in a conservator type transformer
the ability to issue alarms based on trending data, before the alarm condition occurs

The embodiments of the invention in which an exclusive property or privilege is claimed are defined as follows:

1. A dynamic liquid level measuring device for liquid-immersed transformers and reactors or similar liquid-filled equipment with complex and dynamic liquid thermal distributions comprising: liquid pressure measurement sensors, liquid temperature measurement sensors, programmed settings and algorithms to provide an output signal for local or remote liquid level indication.

2. The device defined in claim 1, wherein algorithms calculate and determine alarm outputs based on the measured and programmed data for adverse operational conditions including low liquid level, high liquid level, loss of liquid volume, cooling system restriction, high liquid or gas pressure, low liquid or gas pressure, or breather restriction.

3. The device defined in claim 2, including a local or remote visual display that can be located in any convenient location.

4. The device defined in claim 3 wherein the device may be constructed as a separate component, or functionally incorporated as a component into the design of a related device or devices for monitoring or protecting liquid immersed transformers.
